(19) United States
(12) Patent Application Publication
(10) Pub. No.: US 2014/0067912 A1
(43) Pub. Date: Mar. 6, 2014

(54) System for Remote Server Diagnosis and Recovery

(71) Applicants: Srinivas Reddy Vutukoori, Secunderabad (IN); Shaik Rahimuddin, Hyderabad (IN); Sasidhar Purushothaman, Hyderabad (IN)

(72) Inventors: Srinivas Reddy Vutukoori, Secunderabad (IN); Shaik Rahimuddin, Hyderabad (IN); Sasidhar Purushothaman, Hyderabad (IN)

(73) Assignee: Bank of America Corporation, Charlotte, NC (US)

(21) Appl. No.: 13/602,908

(22) Filed: Sep. 4, 2012

(51) Int. Cl. G06F 15/16

(52) U.S. Cl. 709/203

(57) ABSTRACT

In certain embodiments, a system includes a target server operable to receive commands via an operating system interface. The target server is also operable to run a plurality of processes, a plurality of child processes, and a plurality of threads. The system also includes a diagnostic server, including one or more processors. The diagnostic server is operable to establish a connection to the target server via the operating system interface. The diagnostic server is further operable to identify a process of the plurality of processes running on the target server. The diagnostic server is further operable to identify a child process of the process from the plurality of child processes. The diagnostic server is further operable to identify one or more threads of the plurality of threads associated with one or more of the process and the child process.

### TECHNICAL FIELD OF THE INVENTION

The present disclosure relates generally to server diagnostics and more specifically to a system for remote server diagnosis and recovery.

### BACKGROUND OF THE INVENTION

A server may host a number of applications and/or services. If the server experiences a problem, one or more of these applications and/or services may become unavailable or slow to respond. A user or system administrator may wish to remotely diagnose the problem and recover the server. However, systems supporting remote server diagnosis and recovery have proven inadequate in various respects.

### SUMMARY OF THE INVENTION

In certain embodiments, a system includes a target server operable to receive commands via an operating system interface. The target server is also operable to run a plurality of processes, a plurality of child processes, and a plurality of threads. The system also includes a diagnostic server, including one or more processors. The diagnostic server is operable to establish a connection to the target server via the operating system interface. The diagnostic server is further operable to identify a process of the plurality of processes running on the target server. The diagnostic server is further operable to identify a child process of the process from the plurality of child processes. The diagnostic server is further operable to identify one or more threads of the plurality of threads associated with one or more of the process and the child process. The diagnostic server is further operable to retrieve one or more thread parameters associated with the one or more threads. The diagnostic server is further operable to identify a problem thread of the one or more threads based on the one or more thread parameters. The diagnostic server is further operable to select one of the problem thread, the child process, and the process. The diagnostic server is further operable to terminate the selected one of the problem thread, the child process, and the process.

In further embodiments, a method includes establishing a connection to a target server via an operating system interface. The method also includes identifying a process running on the target server. The method also includes determining whether the process has a child process. The method also includes identifying one or more threads associated with one or more of the process and the child process. The method also includes retrieving one or more thread parameters associated with the one or more threads. The method also includes identifying, by one or more processors, a problem thread of the one or more threads based on the one or more thread parameters. The method also includes selecting, by the one or more processors, one of the problem thread, the child process, and the process. The method also includes terminating the selected one of the problem thread, the child process, and the process.

In additional embodiments, one or more non-transitory computer-readable storage media embody logic that is operable when executed to establish a connection to a target server via an operating system interface. The logic is further operable when executed to identify a process running on the target server. The logic is further operable when executed to determine whether the process has a child process. The logic is further operable when executed to identify one or more threads associated with one or more of the process and the child process. The logic is further operable when executed to retrieve one or more thread parameters associated with the one or more threads. The logic is further operable when executed to identify a problem thread of the one or more threads based on the one or more thread parameters. The logic is further operable when executed to select one of the problem thread, the child process, and the process. The logic is further operable when executed to terminate the selected one of the problem thread, the child process, and the process.

Particular embodiments of the present disclosure may provide some, none, or all of the following technical advantages. By providing remote server diagnosis and recovery, certain embodiments may allow a user to correct a problem with a server without the user having any technical knowledge about the server or how to diagnose server problems. Allowing users to directly correct problems may increase overall server uptime. Moreover, certain embodiments may allow a user and/or a system administrator to obtain operational information about the server and troubleshoot problems with the server without having to log on to the server. By allowing a diagnostic request to specify multiple servers, certain embodiments may increase efficiency and provide a scalable means of correcting problems with large numbers of servers at the same time. Avoiding the need for separate requests for the multiple servers may conserve computational resources and network bandwidth. Certain embodiments may also increase efficiency and reduce the need for human labor by allowing users to correct server problems without having to contact a system administrator. By detecting and correcting excessive processor usage, memory leaks, excessive page faults, or other problems with an application on a server, certain embodiments may conserve computational resources that would otherwise be consumed by the application or server.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example system for remote server diagnosis and recovery, according to certain embodiments of the present disclosure;

FIG. 2 illustrates an example process tree, according to certain embodiments of the present disclosure;

FIG. 3A illustrates a table representing example embodiments of process parameters, according to certain embodiments of the present disclosure;

FIG. 3B illustrates a table representing example embodiments of thread parameters, according to certain embodiments of the present disclosure; and

FIG. 4 illustrates an example method for remote server diagnosis and recovery, according to certain embodiments of the present disclosure.

### DETAILED DESCRIPTION OF THE INVENTION

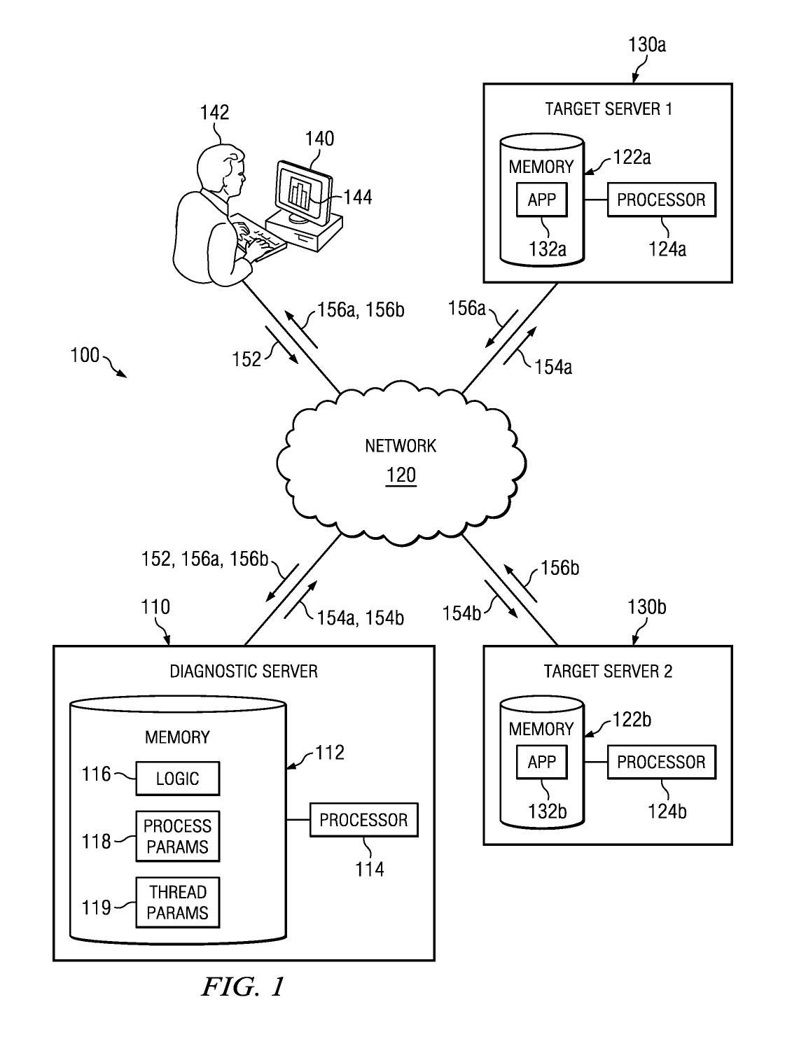

Embodiments of the present disclosure and their advantages are best understood by referring to FIGS. 1 through 4 of the drawings, like numerals being used for like and corresponding parts of the various drawings. FIG. 1 illustrates an example system 100 for remote server diagnosis and recovery, according to certain embodiments of the present disclosure. In general, the system may allow a user and/or a system administrator to detect and fix a problem with a server. In particular, system 100 may include one or more diagnostic servers 110, one or more target servers 130, one or more clients 140, and one or more users 142. Diagnostic server 110, target servers 130a-b, and client 140 may be communicatively coupled by a network 120. Diagnostic server 110 is generally operable to diagnose and correct problems with target servers 130a-b, as described below.

In general, target servers 130a-b may host various applications (e.g. applications 132a-b) that are accessed by one or more users via network 120 (e.g. user 142 using client 140). Although system 100 illustrates target servers 130a-b, it should be understood that system 100 may include any number and combination of target servers 130. If a target server 130 experiences a problem, it may affect and/or degrade the performance of the applications 132 running on it. For example, a target server 130 may be in a hung state, making the running application 132 unresponsive.

As another example, target server 130 may be operating in a sluggish state, making the running application 132 slow to respond. In either instance, a user 142 accessing the application 132 may have a poor user experience, either because application 132 is unresponsive or responds very slowly. To address the problem with the target server 130, a user 142 may send a diagnostic request 152 to diagnostic server 110. In response to the request 152, diagnostic server 110 may communicate with the target server 130 to determine the source of the problem and correct the problem, as described in more detail below. This may allow user 142 to resume normal use of application 132 running on the target server 130.

In some embodiments, target server 130a-b may include, for example, a mainframe, server, host computer, workstation, web server, file server, a personal computer such as a laptop, or any other suitable device operable to process data. In some embodiments, target server 130a-b may execute any suitable operating system such as IBM's zSeries/Operating System (z/OS), MS-DOS, PC-DOS, MAC-OS, WINDOWS, Linux, UNIX, OpenVMS, or any other appropriate operating systems, including future operating systems. In some embodiments, target server 130a-b may be a web server running Microsoft's Internet Information Server™.

In some embodiments, target servers 130a-b may include processor 124a-b and server memory 122a-b. Server memory 122a-b may refer to any suitable device capable of storing and facilitating retrieval of data and/or instructions. Examples of server memory 122a-b include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates server memory 122a-b as internal to target servers 130a-b, it should be understood that server memory 122a-b may be internal or external to target servers 130a-b, depending on particular implementations. Also, server memory 122a-b may be separate from or integral to other memory devices to achieve any suitable arrangement of memory devices for use in system 100.

Server memory 122a-b is generally operable to store one or more applications 132a-b. Applications 132a-b generally refer to software, programs, logic, rules, algorithms, code, and/or other suitable instructions that may be run by or on target servers 130a-b. Server memory 122a-b is communicatively coupled to processor 124a-b. Processor 124a-b is generally operable to execute an application 132a-b stored in server memory 122a-b. Processor 124a-b may include one or more microprocessors, controllers, or any other suitable computing devices or resources. In some embodiments, processor 124a-b may include, for example, any type of central processing unit (CPU). In executing an applications 132a-b, processors 124a-b may utilize one or more processes, child processes, and/or threads. The threads, child processes, and/or processes may be created by applications 132a-b and/or processors 124a-b to support the execution of applications 132a-b. A thread may represent a set of logic or instructions to be executed by the processor. Processors 124a-b may be operable to execute instructions from multiple threads simultaneously. Alternatively, processors 124a-b may be operable to alternate between executing instructions from the various running threads, such that the threads are able to execute virtually simultaneously.

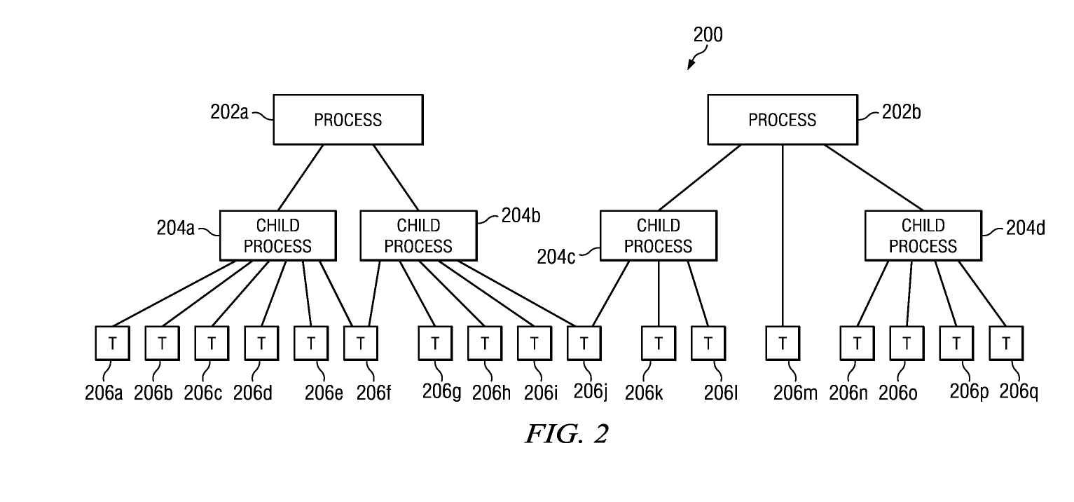

Each thread may be associated with one or more child processes and may share resources with its associated child processes. The child processes, in turn, may be associated with and may share resources with one or more processes (i.e. its parent processes). In some embodiments, the child processes may be created by their associated processes. In certain embodiments, one or more threads may be associated with one or more processes that do not have associated child processes. The threads may execute instructions on processors 124a-b on behalf of their associated processes and child processes. An example process tree, providing a visual representation of the relationships between processes, child processes, and threads, will be described in more detail in connection with FIG. 2.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Client 140 may refer to any device that enables user 142 to interact with diagnostic server 110 and/or target server 130a-b. In some embodiments, client 140 may include a computer, workstation, telephone, Internet browser, electronic notebook, Personal Digital Assistant (PDA), pager, smart phone, tablet, laptop, or any other suitable device (wireless, wireline, or otherwise), component, or element capable of receiving, processing, storing, and/or communicating information with other components of system 100. Client 140 may also comprise any suitable user interface such as a display, microphone, keyboard, or any other appropriate terminal equipment usable by a user 142. It will be understood that system 100 may comprise any number and combination of clients 140. Client 140 may be utilized by user 142 to interact with diagnostic server 110 in order to diagnose and correct a problem with target servers 130a-b, as described below.

In some embodiments, client 140 may include a graphical user interface (GUI) 144. GUI 144 is generally operable to tailor and filter data presented to user 142. GUI 144 may provide user 142 with an efficient and user-friendly presentation of information (such as data 156a-b). GUI 144 may additionally provide user 142 with an efficient and user-friendly way of inputting and submitting diagnostic requests 152 to diagnostic server 110. GUI 144 may comprise a plurality of displays having interactive fields, pull-down lists, and buttons operated by user 142. GUI 144 may include multiple levels of abstraction including groupings and boundaries. It should be understood that the term graphical user interface 144 may be used in the singular or in the plural to describe one or more graphical user interfaces 144 and each of the displays of a particular graphical user interface 144.

In some embodiments, diagnostic server 110 may refer to any suitable combination of hardware and/or software implemented in one or more modules to process data and provide the described functions and operations. In some embodiments, the functions and operations described herein may be performed by a pool of diagnostic servers 110. In some embodiments, diagnostic server 110 may include, for example, a mainframe, server, host computer, workstation, web server, file server, a personal computer such as a laptop, or any other suitable device operable to process data. In some embodiments, diagnostic server 110 may execute any suitable operating system such as IBM's zSeries/Operating System (z/OS), MS-DOS, PC-DOS, MAC-OS, WINDOWS, Linux, UNIX, OpenVMS, or any other appropriate operating systems, including future operating systems. In some embodiments, diagnostic server 110 may be a web server running Microsoft's Internet Information Server™.

In general, diagnostic server 110 performs remote diagnosis and recovery of target servers 130a-b for users 142. In some embodiments, diagnostic server 110 may include a processor 114 and server memory 112. Server memory 112 may refer to any suitable device capable of storing and facilitating retrieval of data and/or instructions. Examples of server memory 112 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates server memory 112 as internal to diagnostic server 110, it should be understood that server memory 112 may be internal or external to diagnostic server 110, depending on particular implementations. Also, server memory 112 may be separate from or integral to other memory devices to achieve any suitable arrangement of memory devices for use in system 100.

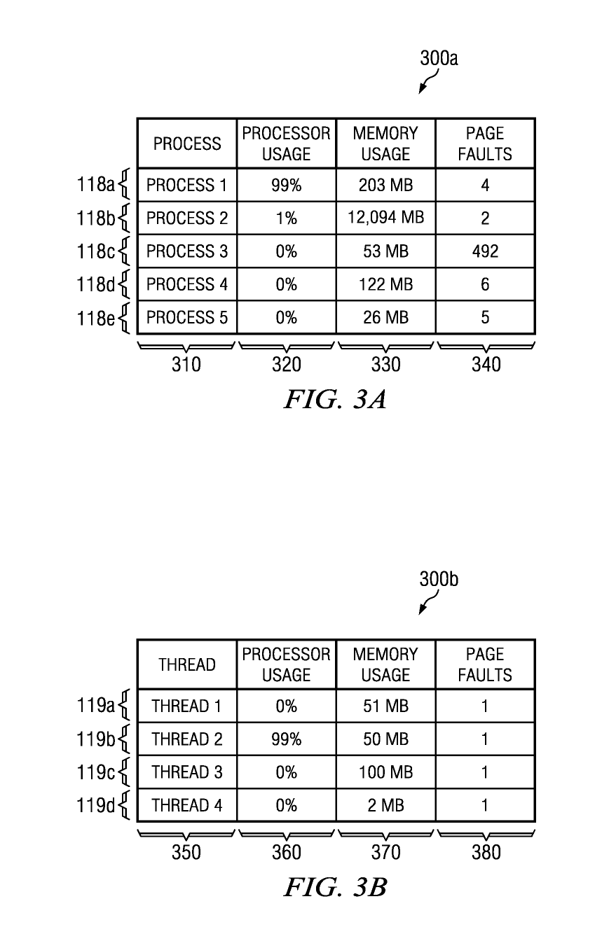

Server memory 112 is generally operable to store logic 116, process parameters 118, and thread parameters 119. Logic 116 generally refers to logic, rules, algorithms, code, tables, and/or other suitable instructions for performing the described functions and operations. Process parameters 118 may be any collection of parameters, statistics, metrics, and/or any other suitable information concerning one or more processes running on a target server 130a-b. In general, process parameters 118 may allow diagnostic server 110 to identify a problem process on a target server 130a-b. Example embodiments of process parameters 118 are described in more detail below in connection with FIG. 3A. Thread parameters 119 may be any collection of parameters, statistics, metrics, and/or any other suitable information concerning one or more threads running on a target server 130a-b. In general, thread parameters 119 may allow diagnostic server 110 to identify a problem thread on a target server 130a-b. Example embodiments of thread parameters 119 are described in more detail below in connection with FIG. 3B.

Server memory 112 is communicatively coupled to processor 114. Processor 114 is generally operable to execute logic 116 stored in server memory 112 to remotely diagnose and recover target servers 130a-b according to this disclosure. Processor 114 may include one or more microprocessors, controllers, or any other suitable computing devices or resources. Processor 114 may work, either alone or with components of system 100, to provide a portion or all of the functionality of system 100 described herein. In some embodiments, processor 114 may include, for example, any type of central processing unit (CPU).

In operation, logic 116, when executed by processor 114, diagnoses and corrects problems with target servers 130a-b for users 142. To perform these functions, logic 116 may first receive a diagnostic request 152, for example from a user 142 via client 140. A diagnostic request 152 may include information identifying a target server 130, such as a server name, IP address, and/or other suitable information. For example, a user 142 may send a diagnostic request 152 indicating a particular target server 130 when that target server 130 is experiencing a problem, such as a hung state or a sluggish state. As another example, a user 142 may send a diagnostic request 152 indicating a particular target server 130 in order to obtain information about that target server 130 even if that target server 130 is not currently experiencing a problem.

Logic 116 may establish a connection to the target server 130 identified in the diagnostic request 152. In some embodiments, logic 116 may connect to target server 130 using an operating system interface. The operating system interface may enable logic 116 to remotely execute commands 154a-b on and retrieve data 156a-b from target server 130. For example, logic 116 may utilize Windows Management Instrumentation (WMI) to establish a connection to and communicate with target server 130.

Logic 116 may be operable to retrieve operational information about target server 130. For example, logic 116 may retrieve information about processor utilization, memory utilization, page file utilization, disk space utilization, server configuration, server uptime, server network interface, server backup status, server ping status, server monitoring agent status, logged-in users, server reboot history, and/or any other suitable information concerning target server 130. Logic 116 may retrieve this information by sending one or more commands 154 to target server 130 via the operating system interface and receiving in response data 156. In some embodiments, logic 116 may send the retrieved operational information and/or data 156 to client 140 for display to user 142 (e.g. via GUI 144).

Logic 116 may be further operable to diagnose and correct a problem with target server 130. Target server 130 may have numerous processes, child processes, and threads running at any given time, as will be discussed in greater detail in connection with FIG. 2. A problem with target server 130 may result from a problem with one or more of these processes, child processes, or threads. Logic 116 may be operable to identify the problem processes, child processes, and/or threads and terminate the appropriate processes, child processes, and/or threads to recover the target server 130, returning it to normal operation.

### Problem Processes

First, logic 116 may identify one or more problem processes. Logic 116 may retrieve the identities of all processes running on target server 130. Logic 116 may also retrieve one or more process parameters 118 concerning each of the running processes. Process parameters 118 may include processor usage, which indicates the degree to which the particular process is utilizing the processor of target server 130 (e.g. processor 124a-b). Processor usage may be expressed as a percentage of the maximum processor capacity or using any other suitable measure. Process parameters 118 may also include memory usage, which indicates the amount of memory the particular process is currently using on target server 130 (e.g. server memory 122a-b). Memory usage may be expressed in kilobytes, in megabytes, in gigabytes, as a percentage of the total available memory, or using any other suitable measure. Process parameters 118 may also include number of page faults, which may indicate the number of times the process attempts to access data that is not loaded into the physical memory, requiring the target server 130 to go to virtual memory to access the data. Process parameters 118 may also include permission information, which may indicate the level of access the particular process has to various hardware and software components of target server 130. Logic 116 may retrieve this information by sending one or more commands 154 to target server 130 via the operating system interface and receiving in response data 156. In some embodiments, logic 116 may store the process parameters 118 in memory (e.g. server memory 112). In some embodiments, logic 116 may be operable to display the process parameters 118 to user 142 via client 140 (e.g. on GUI 144).

Logic 116 may identify the problem process by analyzing the process parameters 118 for each running process. Logic 116 may be operable to detect at least four types of problems: excessive processor usage, memory leaks, excessive page faults, and access control problems. First, logic 116 may identify a process as a problem process if logic 116 detects that the process exhibits excessive processor usage. For example, logic 116 may compare the processor usage to a threshold and detect excessive processor usage if the threshold is exceeded. In some embodiments, logic 116 may be able to distinguish a temporary spike in processor usage by a process from continued excessive processor usage. For example, processor usage exceeding the threshold may trigger logic 116 to retrieve processor usage for the process over a period of time and compare each data point to the threshold. Logic 116 might detect excessive processor usage only if a certain number and/or percentage of these data points exceed the threshold.

Second, logic 116 may identify a process as a problem process if logic 116 detects that the process has a memory leak. A memory leak may occur if a process does not properly release memory that it is no longer using, which could result in the process utilizing more and more memory over time. For example, logic 116 may compare the memory usage to a threshold and detect a memory leak if the threshold is exceeded. In some embodiments, logic 116 may be able to distinguish high memory usage by a process from a memory leak. For example, logic 116 may retrieve memory usage for the process over a period of time and detect patterns in the data points. Logic 116 might detect a memory leak only if the memory usage is increasing at a rate that exceeds a threshold.

Third, logic 116 may identify a process as a problem process if logic 116 detects that the process causes excessive page faults. For example, logic 116 may compare the number of page faults to a threshold and detect excessive page faults if the threshold is exceeded. In some embodiments, logic 116 may detect excessive page faults based on the rate of increase of the number of page faults over time. For example, logic 116 may retrieve number of page faults for the process over a period of time and detect excessive page faults only if the number of page faults is increasing at a rate that exceeds a threshold.

Fourth, logic 116 may identify a process as a problem process if logic 116 detects that the process has an access control problem. This may occur if, for example, the process does not have the permissions necessary to access hardware or software components that the process needs to access in order to run properly. For example, logic 116 may detect an access control problem by checking the permissions of the process to ensure that they are correct. In some embodiments, logic 116 may compare the permissions to known correct permissions for the process.

### Problem Child Processes/Threads

Second, logic 116 may identify one or more problem child processes and/or threads. The problem child processes and problem threads may be associated with the problem process. Thus, once the problem process has been identified, logic 116 may retrieve the identities of all child processes and threads running on target server 130 that are associated with the problem process. Alternatively, logic 116 may identify one or more problem child processes (e.g. by retrieving and analyzing process parameters 118 for each child process associated with the problem process, in the same manner discussed above) and only retrieve the identities of the threads associated with the problem child processes. In either case, logic 116 may retrieve one or more thread parameters 119 concerning each of the identified threads.

Thread parameters 119 may include processor usage, which indicates the degree to which the particular thread is utilizing the processor of target server 130 (e.g. processor 124a-b). Processor usage may be expressed as a percentage of the maximum processor capacity or using any other suitable measure. Thread parameters 119 may also include memory usage, which indicates the amount of memory the particular thread is currently using on target server 130 (e.g. server memory 122a-b). Memory usage may be expressed in kilobytes, in megabytes, in gigabytes, as a percentage of the total available memory, or using any other suitable measure.

Thread parameters 119 may also include number of page faults, which may indicate the number of times the thread attempts to access data that is not loaded into the physical memory, requiring the target server 130 to go to virtual memory to access the data. Thread parameters 119 may also include permission information, which may indicate the level of access the particular thread has to various hardware and software components of target server 130.

Logic 116 may retrieve this information by sending one or more commands 154 to target server 130 via the operating system interface and receiving in response data 156. In some embodiments, logic 116 may store the thread parameters 119 in memory (e.g. server memory 112). In some embodiments, logic 116 may be operable to display the process parameters 118 to user 142 via client 140 (e.g. on GUI 144). Logic 116 may identify the problem thread by analyzing the thread parameters 119 for each identified thread. Logic 116 may be operable to detect four types of problems: excessive processor usage, memory leaks, excessive page faults, and access control problems. These problems may be detected using the methods described above in connection with identifying the problem process.

### Termination

Third, logic 116 may determine which of the problem processes, child processes, and threads should be terminated in order to recover the target server 130 to normal operation. In general, logic 116 will attempt to correct the problem at the lowest level possible in a given situation. The order of preference is as follows from most to least preferred: terminate thread, terminate child process, terminate process. Generally, logic 116 will terminate a problem thread. However, in some situations this may not be possible or desirable because of thread dependencies or associations, and/or for other suitable reasons. For example, other threads may be dependent upon the problem thread. As another example, the problem thread may be associated with multiple child processes and/or multiple processes.

If terminating the thread is not possible, logic 116 will generally terminate a child process associated with a problem thread. However, in some situations this may not be possible because of child process dependencies or because there are no child processes. For example, other processes or child processes may be dependent upon the child process to be terminated. As another example, a problem process may have problem threads associated with it, but no child processes. If terminating the child process is not possible, logic 116 will terminate the problem process. In some embodiments, logic 116 may restart the process, child process, and/or thread that was terminated to allow the target server 130 to resume normal operation. Logic 116 may terminate and/or restart processes, child processes, and/or threads by sending one or more commands 154 to target server 130 via the operating system interface.

In certain embodiments, logic 116 may be operable to receive a diagnostic request 152 that identifies multiple target servers 130. In that situation, logic 116 may be operable to establish a connection to each of the target servers 130 in parallel so that all of the operations described above may be performed essentially simultaneously on all of the target servers 130.

Particular embodiments of the present disclosure may provide some, none, or all of the following technical advantages. By providing remote server diagnosis and recovery, certain embodiments may allow a user to correct a problem with a server without the user having any technical knowledge about the server or how to diagnose server problems. Moreover, certain embodiments may allow a user and/or a system administrator to obtain operational information about the server and troubleshoot problems with the server without having to log on to the server. By allowing a diagnostic request to specify multiple servers, certain embodiments may increase efficiency and provide a scalable means of correcting problems with large numbers of servers at the same time. Certain embodiments may also increase efficiency and reduce the need for human labor by allowing users to correct server problems without having to contact a system administrator.

FIG. 2 illustrates an example process tree 200, according to certain embodiments of the present disclosure. As described above, in executing an application (e.g. applications 132a-b), a processor (e.g. processors 124a-b) may utilize one or more processes, child processes, and/or threads. Process tree 200 provides a visual representation of the relationships between an example set of processes, child processes, and threads.

In the example of FIG. 2, two processes are running on the server, process 202a and process 202b. Process 202a has two child processes associated with it, which may have been created by process 202a to support its execution, child process 204a and child process 204b. Each of those child processes 204a-b has multiple threads associated with it, which may have been created by child processes 204a-b to support their execution. Threads 206a-f are associated with child process 204a and may execute instructions on the processor on behalf of child process 204a and/or process 202a. Threads 206f-j are associated with child process 204b and may execute instructions on the processor on behalf of child process 204b and/or process 202a.

Process 202b is directly associated with thread 206m, which is not associated with any child processes. In addition, process 202b has two child processes associated with it, which may have been created by process 202b to support its execution, child process 204c and child process 204d. Each of those child processes 204c-d has multiple threads associated with it, which may have been created by child processes 204c-d to support their execution. Threads 206j-l are associated with child process 204c and may execute instructions on the processor on behalf of child process 204c and/or process 202b. Threads 206n-q are associated with child process 204d and may execute instructions on the processor on behalf of child process 204d and/or process 202b.

In some embodiments, a thread may be associated with multiple child processes and/or processes. In the example of FIG. 2, thread 206f is associated with both child process 204a and child process 204b and may execute instructions on the processor on behalf of child processes 204a-b and/or process 202a. Similarly, thread 206j is associated with both child process 204b and child process 204c, which are themselves associated with different processes (process 202a and process 202b, respectively). Thread 206j may execute instructions on the processor on behalf of child processes 204a-b and/or processes 202a-b.

Diagnostic server 110 may use the hierarchical nature of processes, child processes, and/or threads running on a target server 130 in diagnosing a problem with an application 132 running on target server 130. For example, diagnostic server 110 may first evaluate all the running processes to identify a problem process (e.g. process 202a) using the techniques described in connection with FIG. 1. Diagnostic server 110 may then determine the child processes associated with that problem process (child processes 204a-b), and identify the threads associated with those child processes (threads 206a-j). Diagnostic server 110 may then evaluate each of those threads to identify a problem thread using the techniques described in connection with FIG. 1. Alternatively, rather than evaluate all the threads associated with the child processes of the problem process, diagnostic server 110 may identify a problem child process of the problem process (e.g. child process 204b), and then evaluate only the threads associated with the problem child process (threads 206f-j). Identification of a problem child process may be performed using the same techniques used to identify a problem process. Thus, diagnostic server 110 may recursively traverse the process tree 200 to identify one or more problem threads.

Once a problem thread, problem child process, and/or problem process has been identified, diagnostic server 110 may use the hierarchical nature of processes, child processes, and/or threads running on a target server 130 to select which of the thread, child process, and/or process should be terminated in order to resolve the problem. In general, diagnostic server 110 will attempt to resolve the problem at the lowest level of process tree 200. In other words, the order of preference is as follows: terminate a problem thread, terminate a problem child process, terminate a problem process. The reason for this may be illustrated by a simple example. Assume thread 206b is identified as the problem thread. If thread 206b is terminated, only thread 206b may be affected. On the other hand, if child process 204a is terminated, all of threads 206a-f may be terminated as well. Similarly, if process 202a is terminated, all of threads 206a-j may be terminated as well.

In some circumstances, it may not be possible or desirable to terminate a problem thread. As one example, thread associations may make it impossible or undesirable to terminate a problem thread. For instance, assume child process 204a is a problem child process and thread 206f is a problem thread. It may not be possible to terminate thread 206f because it is associated with child process 204a and child process 204b. Therefore, diagnostic server 110 may have to terminate child process 204a and/or process 202a in order to resolve the problem. Similarly, assume child process 20b is a problem process and thread 206j is a problem thread. It may not be possible to terminate thread 206j because it is associated with child process 204b and child process 204c, which are themselves associated with different processes (process 202a and process 202b, respectively). Therefore, diagnostic server 110 may have to terminate child process 204b and/or process 202a in order to resolve the problem. As another example, thread dependencies may make it impossible or undesirable to terminate a problem thread. In some embodiments, a thread may be dependent on other threads. Likewise, a process or child process may be dependent on a thread. Assume child process 204c depends upon thread 206k in order to function properly. In such a case, if thread 206k is a problem thread, diagnostic server may need to terminate child process 204c in order to resolve the problem because the dependency may make it impossible or undesirable to terminate the problem thread 206k.

Similarly, in some circumstances, it may not be possible or desirable to terminate a problem child process. As one example, a process may be dependent on a problem thread. Assume process 202b depends upon thread 206p in order to function properly. In such a case, if thread 206p is a problem thread, diagnostic server may need to terminate process 202b in order to resolve the problem because the dependency may make it impossible or undesirable to terminate the problem thread 206k or child process 204d. As another example, a problem thread may not have an associated child process to terminate, such as thread 206m. Therefore, if the problem thread cannot be terminated for some reason, such as a dependency or association with multiple processes, diagnostic server 110 may have to terminate the problem process.

FIG. 3A illustrates a table 300a representing example embodiments of process parameters 119a-e, according to certain embodiments of the present disclosure. As described above in connection with FIG. 1, diagnostic server 110 may retrieve one or more process parameters 118a-e concerning each of the running processes. Table 300a illustrates example process parameters 118a-e for example processes 1-5 respectively, running on a target server 130. In the example of FIG. 3A, for each process (column 310), process parameters 118 include processor usage (column 320), memory usage (column 330), and number of page faults (column 340). In the example, process parameters 118a-e indicate that processes 1-5 have processor usage of 99%, 1%, 0%, 0%, and 0%, respectively. Additionally, process parameters 118a-e indicate that processes 1-5 have memory usage of 203 MB, 12,094 MB, 53 MB, 122 MB, and 26 MB, respectively. Process parameters 118a-e also indicate that processes 1-5 have caused 4, 2, 492, 6, and 5 page faults, respectively.

As described above, diagnostic server 110 may analyze process parameters 118a-e to identify a problem process. For example, diagnostic server 110 may identify a process as a problem process if diagnostic server 110 detects that the process exhibits excessive processor usage or continued excessive processor usage.

Processor usage of 99% for process 1 may indicate that process 1 is a problem process. Diagnostic server 110 may identify process 1 as a problem process because 99% exceeds a threshold (e.g. 95%). On the other hand, high processor usage may simply indicate that process 1 is performing a processor-intensive task at the moment. Therefore, diagnostic server 110 may continue to retrieve and evaluate process parameters 118a for process 1 over time before determining that process 1 is a problem process.

As another example, diagnostic server 110 may identify a process as a problem process if diagnostic server 110 detects that the process has a memory leak, which may be indicated be excessive or increasing memory usage. Memory usage of 12,094 MB for process 2 may indicate that process 2 has a memory leak and therefore is a problem process. Diagnostic server 110 may identify process 2 as a problem process because 12,094 MB exceeds a threshold (e.g. 8,000 MB). On the other hand, high memory usage may simply indicate that process 2 is performing a memory-intensive task at the moment. Therefore, diagnostic server 110 may continue to retrieve and evaluate process parameters 118b for process 2 over time before determining that process 2 is a problem process.

As a third example, diagnostic server 110 may identify a process as a problem process if diagnostic server 110 detects that the process causes excessive page faults or increasing numbers of page faults. 492 page faults for process 3 may indicate that process 3 is a problem process. Diagnostic server 110 may identify process 3 as a problem process because 492 exceeds a threshold (e.g. 100). On the other hand, a large number of page faults may simply indicate that process 3 has recently experienced increased memory needs, or has been executing for a very long period of time and slowly accumulating page faults. Therefore, diagnostic server 110 may continue to retrieve and evaluate process parameters 118c for process 3 over time before determining that process 3 is a problem process.

Once a problem process has been identified (e.g. based on analyzing the process parameters 118a-e), diagnostic server may retrieve thread parameters 119 for one or more threads associated with the problem process and/or child processes of the problem process. FIG. 3B illustrates a table 300b representing example embodiments of thread parameters 119a-d, according to certain embodiments of the present disclosure. In the example of FIGS. 3A-3B, threads 1-4 may be associated with process 1 and/or child processes of process 1.

Table 300b illustrates example thread parameters 119a-d for example threads 1-4 respectively, running on a target server 130. In the example of FIG. 3B, for each process (column 350), thread parameters 119 include processor usage (column 360), memory usage (column 370), and number of page faults (column 380). In the example, thread parameters 119a-d indicate that threads 1-4 have processor usage of 0%, 99%, 0%, and 0%, respectively. Additionally, thread parameters 119a-d indicate that threads 1-4 have memory usage of 51 MB, 50 MB, 100 MB, and 2 MB, respectively. Thread parameters 118a-e also indicate that processes 1-5 have caused 4, 2, 492, 6, and 5 page faults, respectively.

In some embodiments, diagnostic server 110 may narrow down the problems it attempts to detect by analyzing the thread parameters based on the problem that was detected when analyzing the process parameters. In the example of FIGS. 3A-3B, assume that process 1 was identified as a problem process based on excessive processor usage. In analyzing threads 1-4, associated with process 1 and/or child processes of process 1, diagnostic server 110 may speed up the detection process by only attempting to detect excessive processor usage or continued excessive processor usage. Processor usage of 99% for thread 2 may indicate that thread 2 is a problem thread. Diagnostic server 110 may identify thread 2 as a problem thread because 99% exceeds a threshold (e.g. 95%). On the other hand, high processor usage may simply indicate that thread 2 is performing a processor-intensive task at the moment. Therefore, diagnostic server 110 may continue to retrieve and evaluate thread parameters 119b for thread 2 over time before determining that thread 2 is a problem thread In certain other embodiments, the analysis of the thread parameters 119 may be unaffected by the type of problem detected with the problem process.

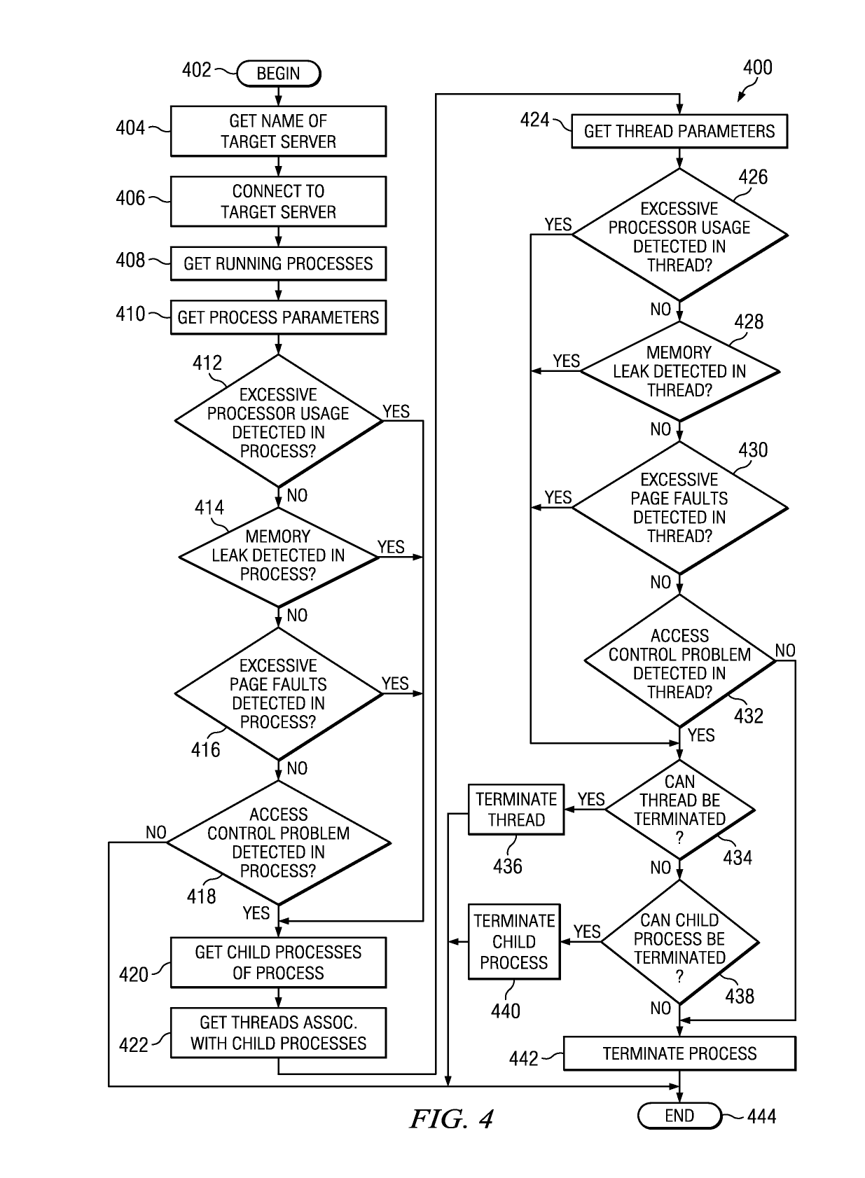

FIG. 4 illustrates an example method 400 for remote server diagnosis and recovery, according to certain embodiments of the present disclosure. The method begins at step 402. At step 404, diagnostic server 110 may get identifying information of a target server 130. The identifying information may include a server name, IP address, and/or any other suitable information. This information may be included in a diagnostic request submitted by a user experiencing a problem with an application, service, or website hosted by target server 130. At step 406, diagnostic server 110 may establish a connection to the target server 130 identified in the diagnostic request. In some embodiments, diagnostic server 110 may connect to target server 130 using an operating system interface. The operating system interface may enable diagnostic server 110 to remotely execute commands on and retrieve data from target server 130. For example, diagnostic server 110 may utilize Windows Management Instrumentation (WMI) to establish a connection to and communicate with target server 130.

At step 408, diagnostic server 110 may retrieve the identities of all processes running on target server 130. At step 410, diagnostic server 110 may also retrieve one or more process parameters concerning each of the running processes. Process parameters may include processor usage, memory usage, number of page faults, permission information, or any other suitable information about the running processes. In some embodiments, the processor parameters may be stored in memory and/or displayed to a user or system administrator.

Diagnostic server 110 may identify the problem process by analyzing the process parameters for each running process. Diagnostic server 110 may be operable to detect four types of problems: excessive processor usage, memory leaks, excessive page faults, and access control problems. At step 412, diagnostic server 110 may examine the process parameters for each running process to detect whether any process exhibits excessive processor usage.

If excessive processor usage or continued excessive processor usage is detected for a process, based on the analysis described above in connection with FIGS. 1 and 3A, diagnostic server 110 may identify that process as a problem process and proceed to step 420. Otherwise, the method proceeds to step 414. At step 414, diagnostic server 110 may examine the process parameters for each running process to detect whether any process exhibits a memory leak.

If a memory leak is detected in a process, based on the analysis described above in connection with FIGS. 1 and 3A, diagnostic server 110 may identify that process as a problem process and proceed to step 420. Otherwise, the method proceeds to step 416. At step 416, diagnostic server 110 may examine the process parameters for each running process to detect whether any process exhibits excessive page faults.

If excessive page faults or excessively increasing page faults are detected for a process, based on the analysis described above in connection with FIGS. 1 and 3A, diagnostic server 110 may identify that process as a problem process and proceed to step 420. Otherwise, the method proceeds to step 418. At step 418, diagnostic server 110 may examine the process parameters for each running process to detect whether any process exhibits access control problems.

If access control problems are detected for a process, based on the analysis described above in connection with FIGS. 1 and 3A, diagnostic server 110 may identify that process as a problem process and proceed to step 420. Otherwise, diagnostic server 110 may determine that there is no detectable problem with target server 130, and proceed to step 444, where the method ends.

At step 420, diagnostic server 110 may retrieve the identities of all child processes running on target server 130 that are associated with the problem process. At step 422, diagnostic server 110 may retrieve the identities of all threads running on target server 130 that are associated with all the identified child processes of the problem process. Alternatively, diagnostic server 110 may identify one or more problem child processes (e.g. by retrieving and analyzing process parameters for each child process associated with the problem process, in the same manner discussed above) and only retrieve the identities of the threads associated with the problem child processes. At step 424, diagnostic server 110 may retrieve one or more thread parameters concerning each of the identified threads. Thread parameters may include processor usage, memory usage, number of page faults, permission information, or any other suitable information about the running threads. In some embodiments, the thread parameters may be stored in memory and/or displayed to a user or system administrator.

Diagnostic server 110 may identify the problem thread by analyzing the thread parameters for each identified thread. Diagnostic server 110 may be operable to detect four types of problems: excessive processor usage, memory leaks, excessive page faults, and access control problems. At step 426, diagnostic server 110 may examine the thread parameters for each identified thread to detect whether any thread exhibits excessive processor usage.

If excessive processor usage or continued excessive processor usage is detected for a thread, based on the analysis described above in connection with FIGS. 1 and 3A-3B, diagnostic server 110 may identify that thread as a problem thread and proceed to step 434. Otherwise, the method proceeds to step 428. At step 428, diagnostic server 110 may examine the thread parameters for each identified thread to detect whether any thread exhibits a memory leak.

If a memory leak is detected in a thread, based on the analysis described above in connection with FIGS. 1 and 3A-3B, diagnostic server 110 may identify that thread as a problem thread and proceed to step 434. Otherwise, the method proceeds to step 430. At step 430, diagnostic server 110 may examine the thread parameters for each identified thread to detect whether any thread exhibits excessive page faults.

If excessive page faults or excessively increasing page faults are detected for a thread, based on the analysis described above in connection with FIGS. 1 and 3A-3B, diagnostic server 110 may identify that thread as a problem thread and proceed to step 434. Otherwise, the method proceeds to step 432. At step 432, diagnostic server 110 may examine the thread parameters for each identified thread to detect whether any thread exhibits access control problems.

If access control problems are detected for a thread, based on the analysis described above in connection with FIGS. 1 and 3A-3B, diagnostic server 110 may identify that thread as a problem thread and proceed to step 434. Otherwise, diagnostic server 110 may determine that there is no detectable problem with any of the identified threads, and proceed to step 442, where it will terminate the earlier-identified problem process.

At step 434, diagnostic server 110 determines whether an identified problem thread can be terminated, based on the analysis discussed above in connection with FIGS. 1 and 2. If so, the method proceeds to step 436, where diagnostic server 110 terminates the problem thread. In some embodiments, diagnostic server 110 may additionally attempt to restart the terminated thread. If not, the method proceeds to step 438. At step 438, diagnostic server 110 determines whether a child process associated with the problem thread can be terminated, based on the analysis discussed above in connection with FIGS. 1 and 2. If so, the method proceeds to step 440, where diagnostic server 110 terminates the child process. In some embodiments, diagnostic server 110 may additionally attempt to restart the terminated child process. If not, the method proceeds to step 442. At step 442, diagnostic server 110 terminates the earlier-identified problem process. In some embodiments, diagnostic server 110 may additionally attempt to restart the terminated process. At step 444, the method ends.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a target server operable to:
receive commands via an operating system interface; and
run a plurality of processes, a plurality of child processes, and a plurality of threads; and
a diagnostic server comprising one or more processors, the diagnostic server operable to:
establish a connection to the target server via the operating system interface;
identify a process of the plurality of processes running on the target server;
identify a child process of the process from the plurality of child processes;
identify one or more threads of the plurality of threads associated with one or more of the process and the child process;
retrieve one or more thread parameters associated with the one or more threads;
identify a problem thread of the one or more threads based on the one or more thread parameters;
select one of the problem thread, the child process, and the process; and
terminate the selected one of the problem thread, the child process, and the process.

2. The system of claim 1, wherein the diagnostic server is further operable to identify the process running on the target server by:
identifying the plurality of processes running on the target server;
retrieving one or more process parameters associated with the plurality of processes; and
selecting the process based on the one or more process parameters.

3. The system of claim 2, wherein the one or more process parameters comprise one or more of:
processor usage;
memory usage; and
number of page faults.

4. The system of claim 1, wherein the diagnostic server is further operable to identify the problem thread of the one or more threads based on the one or more thread parameters by detecting a memory leak in the problem thread.

5. The system of claim 1, wherein the diagnostic server is further operable to identify the problem thread of the one or more threads based on the one or more thread parameters by detecting an access control problem in the problem thread.

6. The system of claim 1, wherein the diagnostic server is further operable to identify the problem thread of the one or more threads based on the one or more thread parameters by detecting a number of page faults in the problem thread, wherein the number of page faults exceeds a threshold.

7. The system of claim 1, further comprising a second target server operable to receive commands via a second operating system interface, and wherein:
the target server is a first target server, the connection is a first connection, the operating system interface is a first operating system interface, and the problem thread is a first problem thread; and
the diagnostic server is further operable to:
establish a second connection to the second target server via the second operating system interface in parallel with the first connection; and
identify a second problem thread running on the second target server.

8. A method, comprising:
establishing a connection to a target server via an operating system interface;
identifying a process running on the target server;
determining whether the process has a child process;
identifying one or more threads associated with one or more of the process and the child process;
retrieving one or more thread parameters associated with the one or more threads;
identifying, by one or more processors, a problem thread of the one or more threads based on the one or more thread parameters;
selecting, by the one or more processors, one of the problem thread, the child process, and the process; and
terminating the selected one of the problem thread, the child process, and the process.

9. The method of claim 8, wherein identifying the process running on the target server comprises:
identifying a plurality of processes running on the target server;
retrieving one or more process parameters associated with the plurality of processes; and
selecting the process based on the one or more process parameters.

10. The method of claim 9, wherein the one or more process parameters comprise one or more of:
processor usage;
memory usage; and
number of page faults.

11. The method of claim 8, wherein identifying the problem thread of the one or more threads based on the one or more thread parameters comprises detecting a memory leak in the problem thread.

12. The method of claim 8, wherein identifying the problem thread of the one or more threads based on the one or more thread parameters comprises detecting an access control problem in the problem thread.

13. The method of claim 8, wherein identifying the problem thread of the one or more threads based on the one or more thread parameters comprises detecting a number of page faults in the problem thread, wherein the number of page faults exceeds a threshold.

14. The method of claim 8, wherein the connection is a first connection, the target server is a first target server, and the problem thread is a first problem thread, and further comprising:
establishing a second connection to a second target server via an operating system interface in parallel with the first connection; and
identifying a second problem thread running on the second target server.

15. One or more non-transitory computer-readable storage media embodying logic that is operable when executed to:
establish a connection to a target server via an operating system interface;
identify a process running on the target server;
determine whether the process has a child process;
identify one or more threads associated with one or more of the process and the child process;
retrieve one or more thread parameters associated with the one or more threads;
identify a problem thread of the one or more threads based on the one or more thread parameters;
select one of the problem thread, the child process, and the process; and
terminate the selected one of the problem thread, the child process, and the process.

16. The one or more non-transitory computer-readable storage media of claim 15, wherein the logic is further operable when executed to identify the process running on the target server by:
identifying a plurality of processes running on the target server;
retrieving one or more process parameters associated with the plurality of processes; and
identifying the process based on the one or more process parameters.

17. The one or more non-transitory computer-readable storage media of claim 16, wherein the one or more process parameters comprise one or more of:
processor usage;
memory usage; and
number of page faults.

18. The one or more non-transitory computer-readable storage media of claim 15, wherein the logic is further operable to identify the problem thread of the one or more threads based on the one or more thread parameters by detecting a memory leak in the problem thread.

19. The one or more non-transitory computer-readable storage media of claim 15, wherein the logic is further operable to identify the problem thread of the one or more threads based on the one or more thread parameters by detecting an access control problem in the problem thread.

20. The one or more non-transitory computer-readable storage media of claim 15, wherein the logic is further operable to identify the problem thread of the one or more threads based on the one or more thread parameters by detecting a number of page faults in the problem thread, wherein the number of page faults exceeds a threshold.
